(19) United States
(12) Patent Application Publication
(10) Pub. No.: US 2012/0176321 A1
(43) Pub. Date: Jul. 12, 2012

(54) Touch-Enabled Personal Mobile Whiteboard Tablet

(75) Inventor: Stephen T. Kaye, Ellicott City, MD (US)

(73) Assignee: EINSTRUCTION CORPORATION, Denton, TX (US)

(21) Appl. No.: 13/345,782

(22) Filed: Jan. 9, 2012

Related U.S. Application Data
(60) Provisional application No. 61/431,143, filed on Jan. 10, 2011.

(51) Int. Cl. G06F 3/045; G06F 3/02; G06F 3/041

(52) U.S. Cl. 345/169; 345/173; 345/174

(57) ABSTRACT

A touch-enabled personal whiteboard tablet (10) includes an electromagnetic digitizer portion (12) having a rigid input surface (14) with no display features. A pen structure (16) is operatively associated with the input surface such that proximity of the pen structure with respect to the input surface, as a result of a user's input, is detected by the digitizer portion. A touch screen display (18) is separate from the digitizer portion and is operatively associated with the input surface such that the user's input to the input surface can be displayed on the touch screen display.

This application claims the benefit of the earlier filing date of U.S. Provisional Application No. 61/431,143, filed on Jan. 10, 2011, which is hereby incorporated by reference into this specification.

### FIELD

The invention relates to digitizers or graphics tablets for use in a classroom or group meeting setting.

### BACKGROUND

U.S. Pat. No. 6,930,673 discloses a collaborative input system for group use. The system includes a plurality of digitizers that communicate with a host computer such that a user's input to one of the digitizers can be received by the host computer and be represented graphically in real time on a common display device. Although this system works well for its intended purpose, the digitizers have no display features. Thus, the user cannot see what he or she has handwritten on the input surface of the digitizer. Furthermore, the digitizers of this conventional system must communicate through the host computer.

Accordingly, there is a need to provide a personal whiteboard tablet which includes the ability for the user to see what he or she has written on the input surface and, when a plurality of tablets are provided, to enable one-to-one communication between tablets.

### SUMMARY

An object of the invention is to fulfill the need referred to above. In accordance with the principles of an embodiment, this objective is obtained by providing a touch-enabled personal whiteboard tablet that includes an electromagnetic digitizer portion having a rigid input surface with no display features. A pen structure is operatively associated with the input surface such that proximity of the pen structure with respect to the input surface, as a result of a user's input, is detected by the digitizer portion. A touch screen display is separate from the digitizer portion and is operatively associated with the input surface such that the user's input to the input surface can be displayed on the touch screen display. When at least a second tablet is provided with each tablet having a transceiver, the tablets are constructed and arranged to communicate directly with each other in a wireless manner via the transceivers

In accordance with another aspect of an embodiment, a method of verifying an input to a personal whiteboard tablet provides a personal whiteboard tablet including an electromagnetic digitizer portion having a rigid input surface and no display features, and a liquid crystal display separate from the digitizer portion and operatively associated with the input surface. A user's input, based on proximity with the input surface, is detected by the digitizer portion and can be displayed on the liquid crystal display.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification.

### BRIEF DESCRIPTION OF THE DRAWINGS

The invention will be better understood from the following detailed description of the preferred embodiments thereof, taken in conjunction with the accompanying drawings, wherein like reference numerals refer to like parts, in which:

FIG. 1 is a front view of a touch-enabled personal whiteboard tablet in accordance with an embodiment of the invention.

FIG. 2 is a rear view of the touch-enabled personal whiteboard tablet of FIG. 1.

FIG. 3 is a front view of a touch-enabled personal whiteboard tablet of FIG. 1, but shown with writing directly on the display.

FIG. 4 shows a plurality of tablets of FIG. 1 used in collaboration, such as in a classroom or group meeting setting using single point wireless communication.

FIG. 5 shows a plurality of tablets of FIG. 1 mounted in a charging station in accordance with an embodiment.

FIG. 6 is a schematic view showing any-to-any communication between tablets or other devices in accordance with an embodiment.

FIG. 7 is a front view of a touch-enabled personal whiteboard tablet in accordance with a second embodiment of the invention.

FIG. 8 is a rear view of the touch-enabled personal whiteboard tablet of FIG. 7.

### DETAILED DESCRIPTION OF EXAMPLE EMBODIMENTS

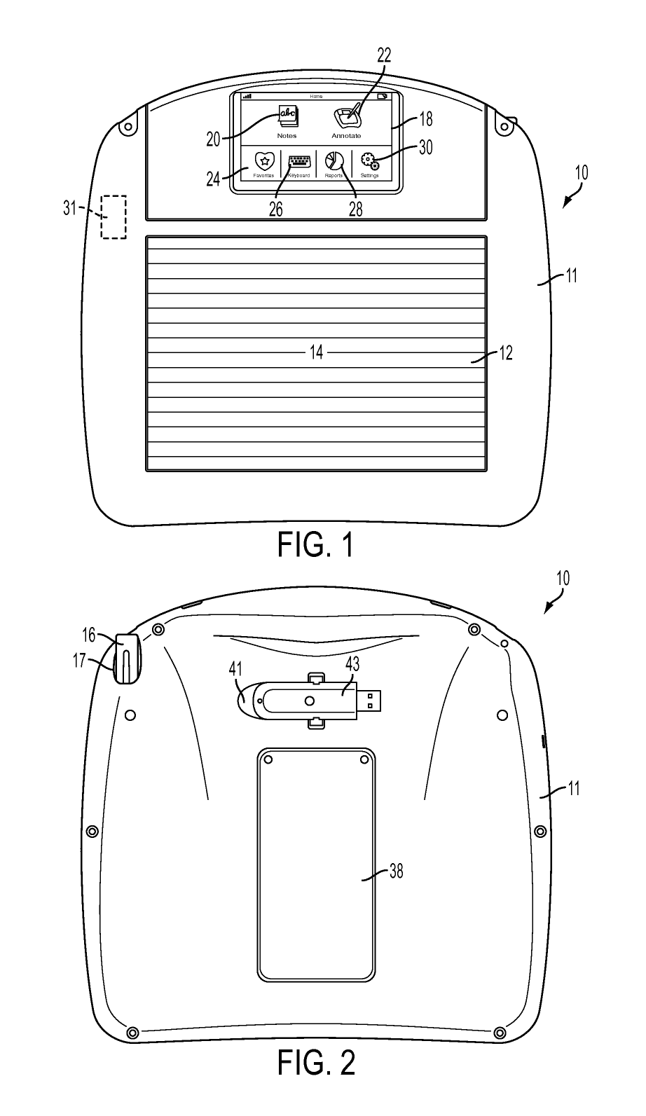

With reference to FIGS. 1 and 2, a touch-enabled personal whiteboard tablet is shown, generally indicated at 10, in accordance with a first embodiment. FIG. 1 is a front view of the tablet 10 and FIG. 2 is a rear view thereof. The tablet 10 includes a housing 11 and an electromagnetic digitizer portion 12 supported by the housing 11. The digitizer portion 12 is pen-based such as, for example, of the type disclosed in U.S. Pat. No. 6,930,673, the content of which is hereby incorporated by reference into this specification. As used herein, the term “digitizer” includes devices such as graphic tablets having an opaque, rigid writing or input surface 14. The input surface 14 has no display features so a user cannot see the result of an input to the input surface 14 on the input surface 14. The digitizer portion 12 is of the conventional electromagnetic coupling type in which exciting lines and detecting lines are arranged in X and Y directions, respectively. The digitizer portion 12 detects changes in the signal levels of the detecting lines due to a magnetic field of a pen structure 16 (shown in a stored position in pen holder compartment 17 in FIG. 2) to thereby detect position of a pen structure 16, when the pen structure is in proximity to the input surface 14. The pen structure 16 is preferably a wireless pen that communicates with the digitizer portion 12 via an electromagnetic wave that is received by a detection circuit of the digitizer portion in the conventional manner. Due to proximity sensing, the pen structure 16 need not contact the input surface 14. The pen holder compartment 17 is associated with a charging circuit to charge a battery of the pen structure 16 while stored therein, when batteries of the tablet 10 are being charged.

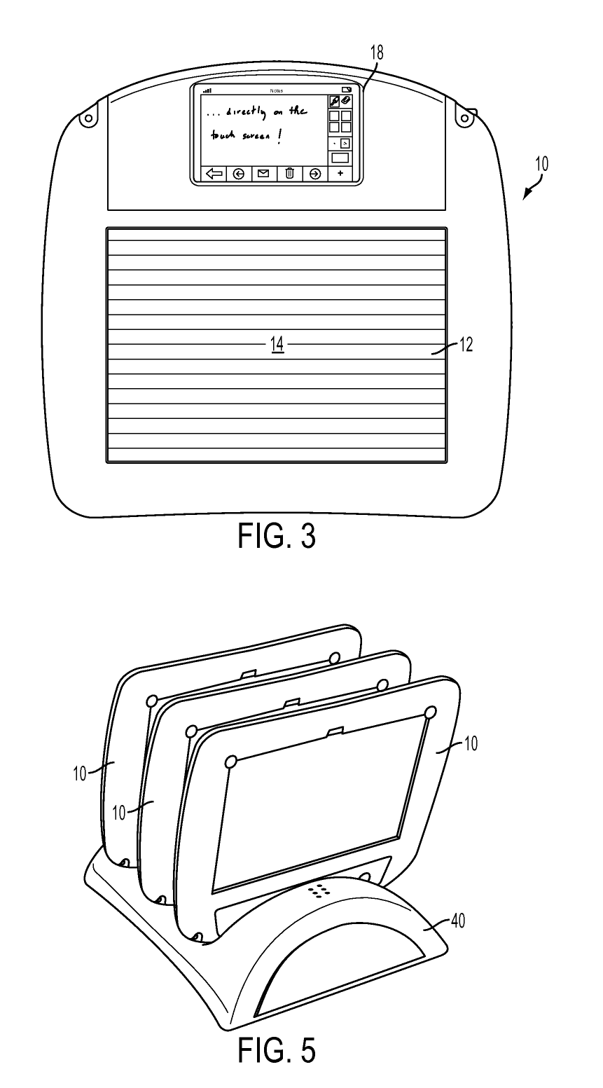

Each tablet 10 includes a color, thin film transistor liquid crystal display, including a touch screen, generally indicated at 18. The touch screen display 18 is preferably of the conventional resistive-type and includes menu defined by a plurality of soft keys 20, 22, 24, 26, and 28 that are user activated by one finger touch in a conventional manner. Firmware, fully embedded in the tablet 10 defines the function and controls the operation of the soft keys. For example, touching the “Notes” key 20, activates an application such that a notes screen will appear on the display 18. As shown in FIG. 3, a user can use the pen structure 16 and write directly on the surface of the display 18 to cause the writing to appear on the display 18. Alternatively, a user can use the pen structure to write on the input surface 14 of the digitizer portion 12 and the display 18 will display what was written on the input surface 14. This is possible by using software to map the input surface 14 to the area of the touch screen display 18. Thus, the user can see what he or she had written on the input surface 14 (prior to sharing it publically) and then can share that information with others by sending the information to the host computer 34 and having it be displayed via the projector 36 or saved at the host computer 34. Alternatively, the notes can be saved in local memory in the tablet 10 if the notes are private.

Soft key 22 “Annotate” is customizable and enables the user to gain quick access to his or her most valued whiteboard annotation tools such as drawing shape, hiding content, annotating, etc. Soft key 24 “Favorites” is customizable and enables user to gain quick access to up to eight of his or her most used applications or websites. Soft key 26 “Keyboard” enables user mobility by enabling the user to enter text quickly on a touch keyboard without the need to return to the computer 34. Soft key 28 “Reports” enables real time formative assessment reports so that a teacher can stay attuned as to how the class, or even an individual student, understands the instruction. Soft key 30 “Settings” enables auto-start of the system software, enables faster classroom setup, and system information enables improved customer support.

With reference to FIG. 2, each tablet 10 is preferably battery operated so as to be portable and includes batteries (not seen) in compartment 38. With reference to FIG. 5, a tablet charging station 40 can be provided, preferably of the type disclosed in co-pending patent application Ser. No. 12/435,460, the contents of which is hereby incorporated by reference into this specification. The charging station 40 can charge the batteries of a plurality of tablets 10 simultaneously. The back of the tablet 10 includes a recess 41 that stores a portable Universal Serial Bus (USB) connector device 43, which can be a wireless USB or WiFi transceiver for connection with a computer.

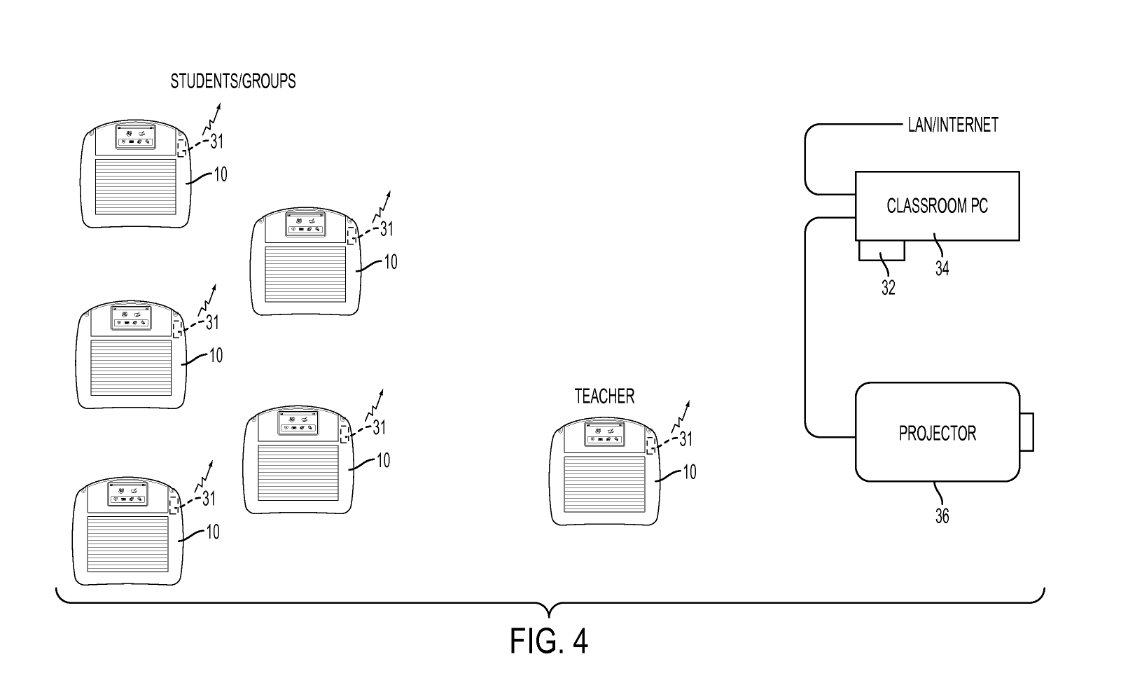

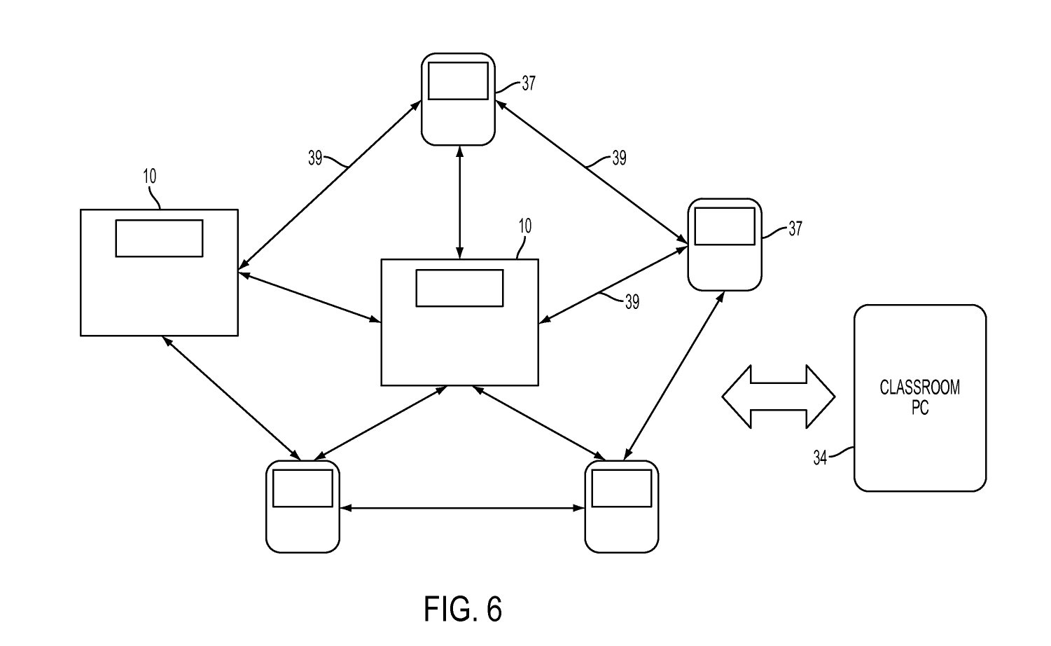

With reference to FIG. 4, the tablet 10 is preferably used in collaboration, such as in a classroom or group meeting setting. In that regard, a plurality of tablets 10 is provided with each tablet 10 including a transceiver 31. Each tablet 10 can communicate via single point wireless communication with a transceiver 32 associated with a host computer 34. The communication scheme is preferably of the type disclosed in the incorporated U.S. Pat. No. 6,930,673. Alternatively, with reference to FIG. 6, the tablets 10′ can be configured for any-to-any wireless communication via the transceivers 31. With this configuration, one tablet 10′ can communicate directly with another tablet 10′ or other device 37 without the need to go through the host computer 34. However, the computer 34 can be the arbiter when two devices or tablets are trying to communicate at the same time since signals from the tablets 10 can be received by transceiver 32 of the host computer 34. Thus, the host computer 34 can prioritize communication between tablets 10. Lines 39 in FIG. 6 indicate text, images, or other content being communicated wirelessly. This communication method creates an opportunity for a highly collaborative classroom teaching and learning experience while providing the teacher ultimate control of the communication pathways.

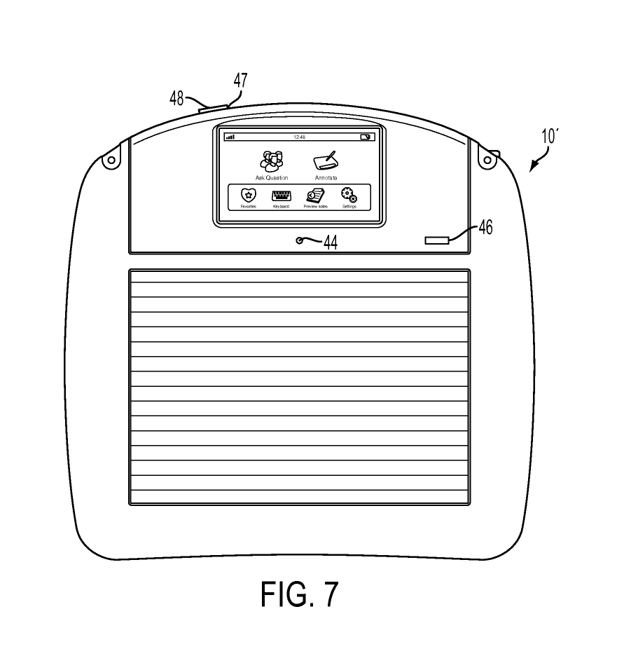

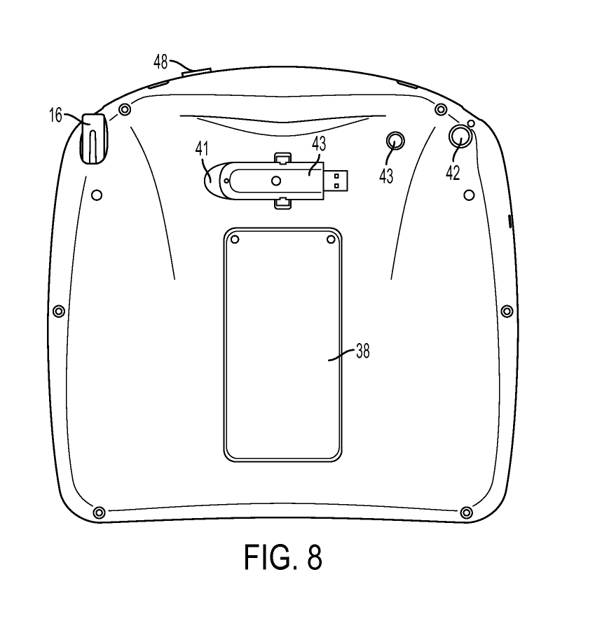

With reference to FIGS. 7 and 8, a second embodiment of a tablet 10′ is shown. The tablet 10′ is similar to the tablet 10 but includes additional features. In particular, the tablet 10′ includes an integrated document camera 42 such that a teacher can capture work on a desktop and send the image to the host computer to be displayed and thus shared with the class. An LED light 43 can be associated with the camera 42. An integrated microphone 44 and speaker 46 are also provided. Thus, using the microphone 44, a user can record his or her voice and store corresponding content written on the tablet 10′ during a “teachable moment” so as to re-experience the moment at a later date. A slot 47 is provided in the housing 11 for receiving a micro SD memory card 48 for extended memory. In addition, a portable USB WiFi transceiver 41 is associated with each tablet 10′ for connection to a computer.

Other features that can be provided on the tablets 10, 10′ is WiFi for connecting to a wireless network and for sending document camera images; Apps; SMS for sending messages back and forth between teacher and students or for allowing students to message with each other; a “Help” button that permits a student privately inform the teacher when the teacher is needed; a video camera; a calculator; an intercom for talking with other tablet users; a universal IR remote control for turning on the classroom lights, closing the window blinds, starting the projector, lowering the screen, all from the tablet 10; a panic button for enhancing classroom safety by enabling a user to quietly notify the principal in the event of an emergency; and a web browser. The tablet 10 can also be configured to send materials so that specialized instruction material can be delivered to students via the tablets 10 and the tablets 10 can be configured to sort data so that student report data can be displayed by student name, grade, and more.

Thus, the tablet 10 provides total mobility within the classroom permitting the teacher to control the lesson anywhere within the classroom. This leads to better classroom management and student engagement. The tablet 10 never needs to be calibrated and there is no high intensity light in the teacher's or student's eyes as with other classroom teaching aids. The tablet is compatible with any projector type and resolution, and is compatible with any display technology (e.g., flat panel, projector, etc.).

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the spirit of the following claims.

What is claimed is:

1. A touch-enabled personal whiteboard tablet comprising:
an electromagnetic digitizer portion having a rigid input surface with no display features,
a pen structure operatively associated with the input surface such that proximity of the pen structure with respect to the input surface, as a result of a user's input, is detected by digitizer portion, and
a touch screen display separate from the digitizer portion and operatively associated with the input surface such that the user's input to the input surface can be displayed on the touch screen display.

2. The tablet of claim 1, in combination with at least a second tablet, each tablet having a transceiver, the tablets being constructed and arranged to communicate directly with each other in a wireless manner via the transceivers.

3. The combination of claim 2, in further combination with a host computer, the host computer having a transceiver constructed and arranged to receive signal from the transceivers of the tablets and to prioritize communication between the tablets.

4. The tablet of claim 1, in combination with a host computer and at least a second tablet, each tablet and the host computer having a transceiver, the transceiver of each tablet being constructed and arranged to communicate in a single point wireless manner with the transceiver of the host computer.

5. The tablet of claim 1, wherein the touch screen display is a liquid crystal, resistive-type display and includes a menu having touch enabled soft keys, the tablet being constructed and arranged such that when at least one of the soft keys is touched, the user's input to the input surface is permitted to be displayed on the touch screen display.

6. The tablet of claim 5, wherein the tablet is constructed and arranged such that when the at least one soft key is touched, the user can write on the touch screen display with the pen structure.

7. The tablet of claim 5, wherein a soft key is provided for permitting annotation, accessing applications or websites, activating a touch-enabled keyboard, to access reports, or accessing settings associated with the tablet.

8. The tablet of claim 1, wherein the tablet is constructed and arranged to be battery powered so as to be portable.

9. The tablet of claim 1, wherein a housing of the tablet includes a recess storing a portable universal serial bus (USB) WiFi transceiver, the transceiver being constructed and arranged to be connected to a computer.

10. The tablet of claim 1, further comprising an integrated document camera.

11. The tablet of claim 1, further comprising an integrated microphone.

12. The tablet of claim 1, further comprising a slot for receiving a micro memory card.

13. The tablet of claim 1, wherein a housing of the tablet includes a pen holder compartment constructed and arranged to receive the pen structure therein.

14. The tablet of claim 13, wherein the tablet is constructed and arranged to charge a battery of the pen structure while in the pen holder compartment, when batteries of the tablet are being charged.

15. A method of verifying an input to a personal whiteboard tablet, the method comprising the steps of:
providing a personal whiteboard tablet including an electromagnetic digitizer portion having a rigid input surface and no display features, and a liquid crystal display separate from the digitizer portion and operatively associated with the input surface, and
permitting a user's input, based on proximity with the input surface, to be detected by the digitizer portion and to be displayed on the liquid crystal display.

16. The method of claim 15, wherein the liquid crystal display is of the touch enabled resistive type, the method further including:
providing a menu on the display including touch enabled soft keys, and
permitting, after at least one of the soft keys is touched, the user's input to be displayed on the liquid crystal display.

17. The method of claim 16, wherein, when the at least one soft key is touched, permitting the user to write on the touch screen display, with the writing being displayed on the touch screen display.

18. The method of claim 15, wherein the user's input is provided by proximity of a pen structure with respect to the input surface.

19. The method of claim 17, wherein the user's input is provided by proximity of a pen structure with respect to the input surface, and further comprising:
using the pen structure to write on the touch screen display.

20. The method of claim 15, further comprising:
providing a plurality of the personal whiteboard tablets, and permitting the tablets to communicate directly with each other in a wireless manner.
